(19) United States
(12) Patent Application Publication
(10) Pub. No.: US 2025/0208397 A1
(43) Pub. Date: Jun. 26, 2025

(54) OPTICAL SYSTEM FOR A METROLOGY SYSTEM AND METROLOGY SYSTEM WITH SUCH AN OPTICAL SYSTEM

(71) Applicant: Carl Zeiss SMT GmbH, Oberkochen (DE)

(72) Inventors: Manuel Decker, Jena (DE); Matthias Wald, Jena (DE); Arne Schob, Jena (DE); Markus Koch, Neu-Ulm (DE)

(21) Appl. No.: 18/986,898

(22) Filed: Dec. 19, 2024

(30) Foreign Application Priority Data
Dec. 22, 2023 (DE) 102023213275.3

(51) Int. Cl. G02B 21/00; G02B 21/26

(52) U.S. Cl. CPC G02B 21/006; G02B 21/0032; G02B 21/008; G02B 21/26

(57) ABSTRACT

An optical system for a metrology system serves to measure an object. An optical focusing component is arranged in the beam path of illumination light between a light source and an object field and serves to create an illumination focus. A detection device serves to capture the illumination light in the beam path downstream of the object field. The optical focusing component is embodied as a zone plate with at least two zones. Portions of the illumination light that are incident on the zones interact with each other by diffraction. Depending on the embodiment of the zone plate, the zones of the zone plate are arranged in such a way that the zone plate is chromatically corrected for the illumination light, the zone plate is aspherically corrected for the illumination light, the zones of the zone plate have a reflective embodiment for the illumination light, and/or the zones of the zone plate are arranged in such a way that at least one order of diffraction of the illumination light is preferred as predetermined order of diffraction in comparison with at least one further order of diffraction as regards the used illumination light intensity guided by the zone plate. This results in an optical system in which the zone plate design options for the optical focusing component are optimized in order to improve application options for the metrology system.

### CROSS-REFERENCE TO RELATED APPLICATION

The present patent application claims the priority of German patent application DE 10 2023 213 275.3, filed on Dec. 22, 2023, the entire content of which is incorporated by reference herein.

### TECHNICAL FIELD

The invention relates to an optical system for a metrology system for measuring an object. The invention further relates to a metrology system for measuring an object using such an optical system.

### BACKGROUND

A metrology system of the aforementioned type is known from US 2012/0008123 A1, for example. Further systems for measuring lithographic masks are known from the specialist articles by Na J. et al. “Application of actinic mask review system for the preparation of HVM EUV lithography with defect free mask,” Proc. of SPIE Vol. 10145, 101450M-1, by Goldberg K. et al. “Actinic mask imaging: recent results and future directions from the SHARP EUV microscope,” Proc. of SPIE Vol. 9049, 90480Y-1, and by Naulleau et al. “Electro-optical system for scanning microscopy of extreme ultraviolet masks with a high harmonic generation source,” Optics Express, Vol. 22, 20144, 2014. Another metrology system is known from U.S. Pat. No. 9,904,060. DE 10 2017 205 629 A1 discloses a method and an apparatus for repairing defects of a photolithographic mask for the EUV range. DE 101 25 870 A1 discloses an optical element for imaging objects and/or for focusing electromagnetic beams or beams of elementary particles. DE 102 42 431 A1 discloses an element for focusing electromagnetic beams or beams of elementary particles. DE 102 61 137 A1 discloses a projection optical unit for lithography and a mirror for same. DE 10 2022 114 158 A1 discloses an apparatus and a method for characterizing a microlithographic mask.

### SUMMARY

A problem addressed by the present invention is that of developing an optical system for a metrology system in such a way that zone plate design options for the optical focusing component are optimized in order to improve application options for the metrology system.

According to the invention, this problem is solved by an optical system having the features specified in Claim 1 and also solved according to the invention by an optical system having the features specified in Claim 2.

The invention identified that zone plates offer design options that lead to optical properties which can be used to improve the application options of the metrology system.

A chromatic correction of the zone plate according to a first aspect avoids unwanted chromatic aberrations.

An aspherical correction of the zone plate according to a further aspect avoids unwanted aberrations and/or creates the possibility of compensating or correcting aberrations that are created via other components of the metrology system and/or creates the possibility of selectively introducing aberrations into the metrology system.

A reflective embodiment of the zones of the zone plate according to a further aspect leads to the possibility of increasing an illumination light throughput of the metrology system. This can improve measurement accuracy and/or reduce requirements for a light source of the metrology system.

A configuration of a zone plate according to a further aspect that is selective with regard to at least one predetermined order of diffraction also leads to an increase in throughput and can moreover avoid the occurrence of undesirable extraneous light or the occurrence of undesirable channel crosstalk in a detection device that is spatially resolved in that case. The zone plate may be embodied in particular for chromatic correction of a diffraction of the illumination light.

In some implementations, a focal length of the optical focusing component, i.e. the zone plate, cannot exceed 10 mm. For example, the focal length can be 5 mm or 0.5 mm. An optical focusing component with a correspondingly short focal length allows for a correspondingly small illumination focus with the advantages associated therewith, for example in terms of resolution in object measurement. Corresponding advantages particularly take effect in the reflective embodiment of the zone plate and in the embodiment of the zones in the zone plate, according to Claim 2, such that one order of diffraction of the illumination light is preferred.

A total number of zone rings according to Claim 3 leads to an advantageous diffraction effect of the zone plate. The number of zone rings can be greater than 150, can be greater than 200 and can also be greater than 250. The number of zone rings is regularly less than 1000.

An embodiment of the zone plate as transmitting phase plate according to Claim 4 has proven its worth in practice.

An embodiment of the zone plate as a photon sieve according to Claim 5 allows for a chromatic correction of the zone plate in particular. A pinhole diameter in the photon sieve can be of the order of a radial extent of a width of the respective zone ring. Reflective elements of a corresponding extent can also be used instead of pinholes but are also referred to as pinholes below. The pinholes can be distributed randomly over the respective zone ring. The pinholes can have a binary distribution within a specific zone ring, i.e. a cumulative circumference of the holes of all pinholes can correspond to a cumulative interspace circumference of interspaces between respective pinholes adjacent in the circumferential direction of the respective zone ring.

An embodiment of the photon sieve according to Claim 6 avoids undesirable extraneous light. The preferred order of diffraction can be a plus/minus first order of diffraction. The photon sieve may be embodied such that a zeroth order of diffraction is suppressed.

An aspherical correction characteristic according to Claim 7 represents an option for the design of an aspherically corrected zone plate. An aspherical correction may have a radial distribution of the ring widths of the zone rings that corresponds to that of one rotationally symmetric Zernike polynomial or the sum of a plurality of rotationally symmetric Zernike polynomials, for example the Zernike polynomial Z36. An aspherical correction may also have a distribution of the ring widths of the zone rings that deviates from rotational symmetry and corresponds to that of any desired Zernike polynomial or the sum of a plurality of any desired Zernike polynomials, for example the Zernike polynomial Z8.

A design according to Claim 8 enables an embodiment of the zone plate as a reflective zone plate. The reflection layer can be embodied as a multilayer layer.

A design according to Claim 9 for example allows the zone plate to be designed as a chromatically corrected zone plate. In particular, the zone layer may comprise a plurality of absorber layers, wherein different absorber material can be used in each absorber layer. The optionally different absorber layers can then be assigned to zones that are optimized for different wavelengths.

A design according to Claim 10 enables a highly reflective embodiment of the zone plate.

Insofar as the zone layer comprises a multilayer portion of the reflection layer, a chromatically corrected zone plate can be realized in turn, wherein a zone layer portion made of an absorber layer and another zone layer portion are designed as a reflective multilayer layer.

An embodiment according to Claim 11 results in a variety of design options for the zones of the zone plate. The zones can have a sawtooth profile, allowing a blazed embodiment of the zone plate. The zones can be embodied as a step profile with at least two steps of differing step height. This can be used, for example, to approximate a continuous cross-sectional profile of the zones, for example approximate a sinusoidal or blazed profile that is as complete as possible. A rectangular envelope of a respective zone ring can be subdivided into a plurality of radially spaced profile sections of the same step height. This can be used to specify specific preferred orders of diffraction of the illumination light that are guided over the zone plate.

The advantages of a metrology system according to Claim 12 correspond to those which have already been explained above with reference to the optical system. A spectral width Δλ/λ (FWHM, full width at half maximum) of the illumination light created by the light source can be at least 5×10⁻⁴, at least 1×10⁻³, at least 3×10⁻³, at least 5×10⁻³, at least 1×10⁻², at least 1×10⁻¹, and can lie in the range between 1/250 and 1/300, for example.

The optical system can be a constituent part of a scanning EUV microscope. A scanning EUV microscope is otherwise described in the specialist article “Electro-optical system for scanning microscopy of extreme ultraviolet masks with a high harmonic generation source,” Optics Express, Vol. 22, 20144, 2014, by Naulleau et al.

An EUV light source according to Claim 13 enables actinic measurement, in particular of an EUV lithography mask as the object. The EUV light source can be a plasma light source pumped by a solid-state laser in particular or else be a high harmonic generation (HHG) light source.

### BRIEF DESCRIPTION OF THE DRAWINGS

Exemplary embodiments of the invention are explained in detail below with reference to the drawing, in which:

FIG. 1 schematically shows a meridional section through a metrology system for measuring an object, comprising a zone plate, which is embodied as a transmissive zone plate, in an illumination light beam path upstream of an object field;

FIG. 2 shows, in an illustration similar to FIG. 1, a further embodiment of a metrology system having a reflective zone plate in the illumination light beam path upstream of the object field;

FIG. 3 shows, in a perspective and also schematic view that is not to scale, a zone plate for the elucidation of parameters that are relevant to the zone plate design;

FIG. 4 shows a process description for elucidating an embodiment of the zone plate as a chromatically corrected photon sieve;

FIG. 5 shows an enlarged meridional section, not to scale, of an elucidation of a diffractive effect of the photon sieve or of a zone lens, wherein beam paths of different orders of diffraction are emphasized;

FIG. 6 shows, in an illustration similar to FIG. 4, a scheme for the design of a further embodiment of a zone plate, which is aspherically corrected in this case;

FIG. 7 shows a cross section of an embodiment of a reflective zone plate having a zone layer that is designed as a multilayer layer like a reflection layer of the zone plate;

FIG. 8 shows, in an illustration similar to FIG. 7, an embodiment of a reflective zone plate having a zone layer that comprises a multilayer portion of the reflection layer and an absorber portion arranged thereabove;

FIG. 9 shows, again in an illustration similar to FIG. 7, an embodiment of a reflective zone plate, in which a zone layer as a whole is embodied as an absorber layer made of an absorber material;

FIG. 10 shows, again in an illustration similar to FIG. 7, an embodiment of a reflective zone plate, in which the zone layer is embodied in steps in two layers as an absorber layer, with each of the two layers being made of a different absorber material;

FIG. 11 shows, in a section, a cross section through a few adjacent zone rings of an embodiment of the zone plate in which exactly one order of diffraction, as predetermined order of diffraction, is preferred in comparison with other orders of diffraction of the illumination light guided by the zone plate, wherein the zone rings are embodied with a sawtooth profile in cross section;

FIG. 12 shows, in an illustration similar to FIG. 11 and for comparison purposes, a diffractive effect of zone rings embodied in binary rectangular fashion in cross section, wherein the diffractive effect for different orders of diffraction is shown;

FIG. 13 shows, again in an illustration similar to FIG. 11, a diffractive effect of zone rings embodied as two step profiles of different step height in cross section, wherein the diffractive effect for different orders of diffraction is also shown here, in a manner corresponding to the illustration in FIG. 12;

FIG. 14 shows, again in an illustration similar to FIG. 11, a diffractive effect of an embodiment of the zone rings as a subdivision of a rectangular envelope into a plurality of radially spaced apart profile sections with the same step height, wherein the diffractive effect for different orders of diffraction is shown;

FIG. 15 shows, in an illustration similar to FIG. 11, an embodiment of the zone plate with sinusoidal zone rings in cross section; and

FIG. 16 shows, again in an illustration similar to FIG. 11, an embodiment of the zone plate with zone rings, designed as step profiles with a total of three steps and two step heights each.

### DETAILED DESCRIPTION

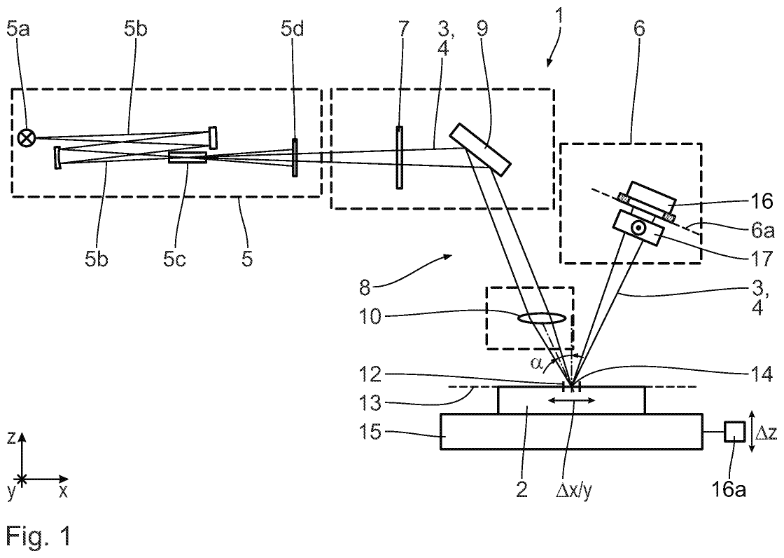

FIG. 1 schematically shows a metrology system 1 for measuring an object 2. An example of the object 2 to be measured is a lithography mask for projection lithography for the production of microstructured or nanostructured semiconductor components. A beam path of a beam 3 of illumination light 4, delimited to the edge, is shown between a light source 5 and a detection device 6 of the metrology system 1.

The light source 5 is, e.g., an EUV light source for creating the EUV illumination light 4 with a central used wavelength in the range between 5 nm and 30 nm, in particular at 13.5 nm. A spectral width Δλ/λ) (FWHM, full width at half maximum) of the EUV illumination light 4, which is used to illuminate the object 2, is at least 1×10⁻⁴ and may lie in the range between 1/250 and 1/300, for example. The light source 5 can be, e.g., a plasma light source or a HHG light source. In the schematically illustrated variant of the light source 5, the latter comprises a pump laser 5a in the form of a Ti:sapphire laser, whose pump light 5b is focused by use of a mirror focusing optical unit into a gas cell 5c for the creation of the illumination light 4. A pinhole 5d of the light source 5 serves to separate the illumination light 4 from the pump light 5b.

The pinhole 5d can additionally be used to separate the used illumination light 4 from in particular unwanted debris which is also carried along. An extraneous light filter 7 for separating the used illumination light 4 from undesirable wavelength components contained in the beam path can be arranged in the beam path of the illumination light 4 downstream of the light source 5.

Downstream of the light source 5, the illumination light 4 is guided by an optical system 8 of the metrology system 1. The optical system 8 comprises an EUV mirror 9 and an optical focusing component in the form of a zone plate 10, various exemplary embodiments of which will be explained below. The optical focusing component 10 is arranged in the beam path of the illumination light 4 between the light source 5 and an object field 12 in an object plane 13 of the optical system 8. The optical focusing component 10 serves to create an illumination focus 14 in the beam path of the illumination light 4 downstream of the optical focusing component 10.

A focal length of the optical focusing component 10 is no more than 10 mm and typically 0.5 mm.

The zone plate 10 is embodied to be transmissive to the illumination light 4, and thus allows at least portions of the latter to pass. The zone plate 10 is embodied as a transmitting phase plate, wherein zones of the zone plate 10 have a different effect on the phase of illumination light 4 incident on the zone plate 10.

To clarify positional relationships between components of the metrology system, a Cartesian xyz coordinate system is drawn in FIG. 1. The x-direction runs to the right in FIG. 1. The y-direction runs into the plane of the drawing at right angles thereto in FIG. 1. The z-direction runs upwards in FIG. 1.

An object holder 15 of the optical system is used to hold the object 2 in the object plane 13 such that a portion of the object 2 is located in the object field 12. Via an actuator 16, the object holder 15 is displaceable perpendicular to the object plane 13, as is illustrated by a double-headed displacement arrow Δz in FIG. 1. Via the actuator 16a, the object holder 15 with the object 2 can also be displaced parallel to the object plane 13, as is illustrated by a double-headed arrow Δx/y in FIG. 1.

A chief ray angle α, at which the illumination light 4 is incident on the object field 12, can be less than 6°. The chief ray angle refers to the angle between the chief ray and a direction perpendicular to the object plane.

An object-side numerical aperture of the illumination light beam path can be in the range between 0.075 and 0.2, in particular of the order of 0.1.

The object 2 is embodied as a reflective object. Illumination light 4 reflected by the object 2 is guided as detection light from the optical system 8 to the detection device 6.

An aperture stop 17, which is shown in FIG. 1 in a plan view for illustrative purposes, is arranged in the beam path of the illumination light 4 between the object field 12 and a spatially resolving detector 16 of the detection device 6. The aperture stop 17 may additionally have an inner obscuration stop section. The aperture stop 17 can be embodied to replicate an exit pupil of a projection optical unit of a projection exposure apparatus, the imaging effect of which can then be simulated.

Depending on the embodiment, the detection device 6 can have two, three, five, ten or even more sensor elements. The detection device 6 can be designed as a sensor line or as a two-dimensional sensor array, for example in the form of a charged coupled device (CCD) or complementary metal-oxide-semiconductor (CMOS) array. The detector 16 of the detection device 6 is arranged in an arrangement or detection plane 6a.

The detector 16 is used to capture a diffraction field of an object point of the object field 12. The light transmitted through the aperture stop 17 is integrated by use of the detector 16 and defines an intensity ascertained for the respective measured object point. Scanning over the object 2 results in an image of the object 2 from the image points hereby assigned to the individual object points.

The zone plate 10 serves to predetermine an illumination angle distribution and/or an illumination intensity distribution of the illumination light 4 over the object field 12, in particular a point illumination of the object, which is adapted to an illumination setting of a projection exposure apparatus for EUV lithography. Moreover, the chief ray angle α is also specified by way of the zone plate 10.

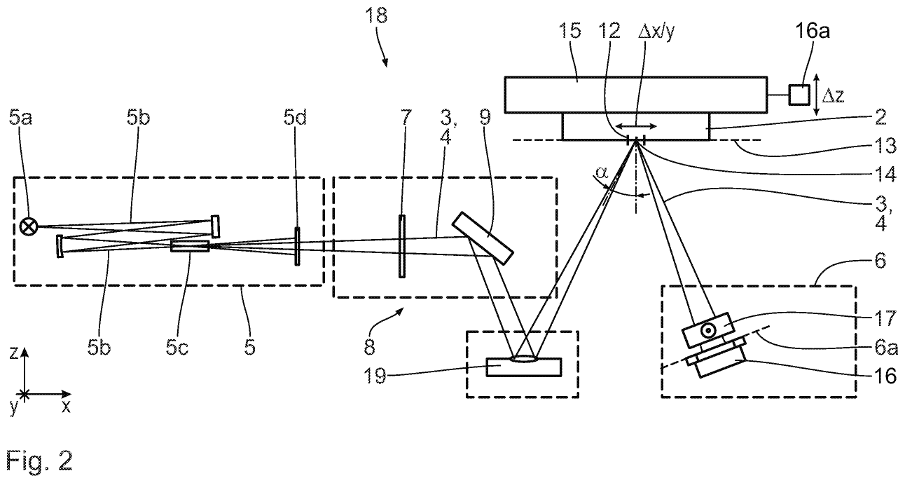

FIG. 2 shows a further embodiment of the metrology system 18. Components and functions corresponding to those which have already been explained above with reference to FIG. 1 bear the same reference signs, in particular, and will not be discussed in detail again.

A zone plate 19, which fundamentally has the function of the zone plate 10 according to FIG. 1, has a reflective embodiment in the metrology system 18.

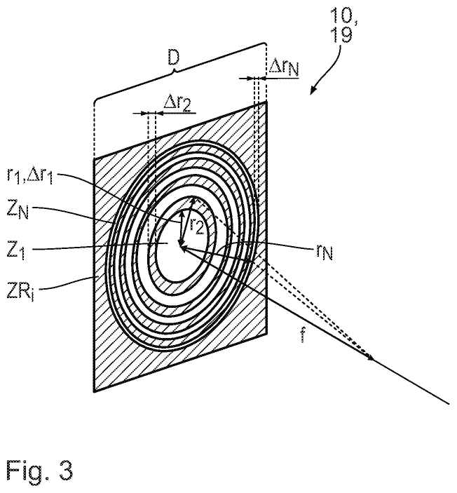

FIG. 3 schematically shows a distribution of zones Z₁ to Z_{N} of the zone plates 10 and 19. Along a radius coordinate r with an origin at a center of the zone plate 10, 19, each of the zones Zᵢ is located in a zone ring ZRᵢ at a ring radius rᵢ (i=1, . . . N). In FIG. 3, the zone plate includes areas shown in white and areas shown in hatched lines. These white/hatched areas refer to different effects of the respective area on the illumination light 4 impinged upon these areas. In case of the transmissive zone plate 10, for example the white areas have a first phase effect, e.g. a phase shift of 0, and the hatched areas have a second phase effect, e.g. a phase shift of π/n (n=integer from 1 to 100) on the illumination light 4 impinging such transmitting zone plate 10. In the case of the reflective zone plate 19, the white/hatched areas refer to areas of different, specific reflectivities R₁ (for the white areas) and R₂ (for the hatched areas). In general, R₁≠R₂.

The respective ring radius Rᵢ refers to an outer radius of the respective zone ring ZRᵢ. For i≥2, each zone Zᵢ is defined by an inner boundary, i.e. the ring with inner radius rᵢ₋₁, and an outer boundary, i.e. the ring with radius r₁.

The number N of zone rings ZRᵢ is significantly understated in FIG. 3. In fact, this number N is in the range of between 50 and 500, for example between 200 to 300, and for example is around 250.

The zone plate 10 or 19 has an entrance pupil diameter D that corresponds to a diameter of the outermost zone Z_{N}. The diameter D can be in the range of between 10 μm and 250 μm, for example in the range of between 50 μm and 150 μm and for example can be around 80 μm.

Furthermore, the zone plate 10, 19 has a focal length f. The focal length f can be in the range of between 0.25 mm and 10 mm, for example at 0.5 mm.

The following applies to a radial extent Δr₁ of an innermost zone ring ZR₁, i.e. the outer boundary of inner zone Zᵢ: 20 nm≤Δr₁≤200 nm. The innermost zone ring ZR₁ has the shape of a circular disc. This radial extent Δr₁ can be of the order of 80 nm, for example. This radial extent Δrᵢ generally decreases towards the radially outer zone rings ZRᵢ in a defined manner, and so there is a desired diffraction effect of the zone plate 10, 19 for the illumination light 4.

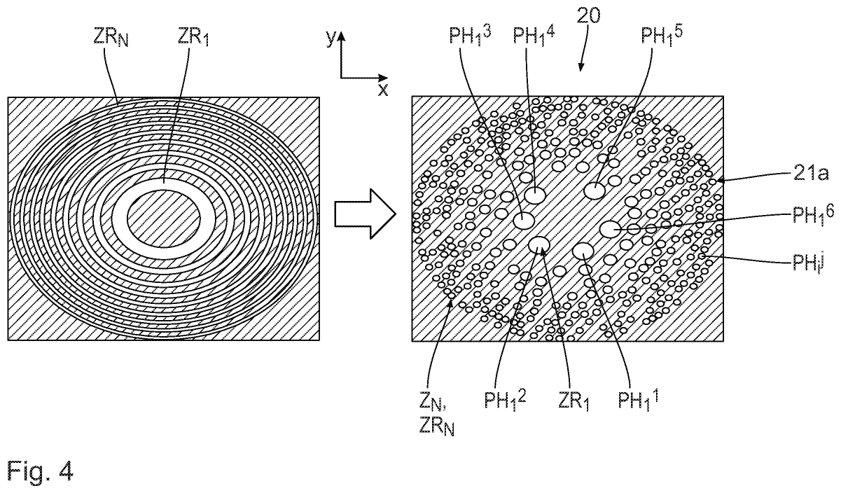

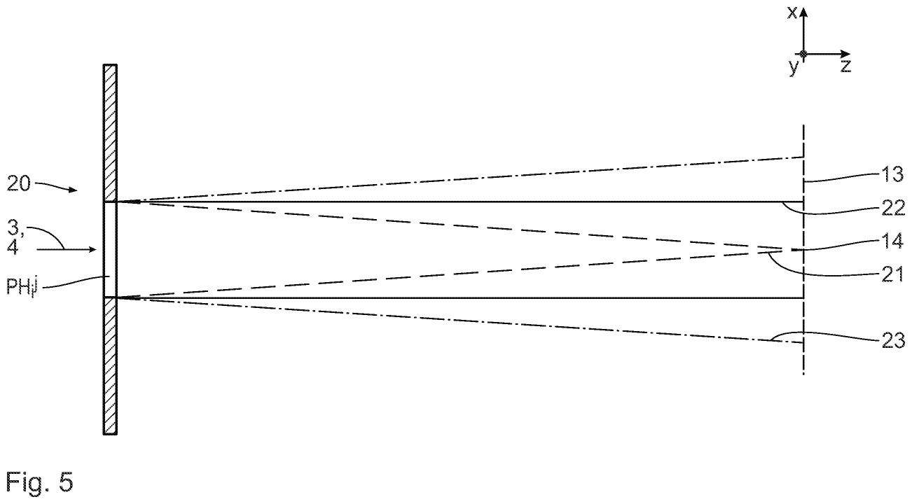

With reference to FIGS. 4 to 5, a description is given below of an embodiment of a zone plate 20, which can be used instead of the zone plate 10 or 19. Components and functions corresponding to those which have already been explained above with reference to FIGS. 1 to 3 bear the same reference signs and will not be discussed in detail again.

FIG. 4 shows a process description for embodying a zone plate 20, which can be used instead of the zone plate 10 or 19. The zone plate 20 is embodied as a photon sieve. The zone plate 20 is chromatically corrected for the illumination light 4.

A zone plate is an optical component having at least two zones, wherein a portion of the illumination light that is incident on a first of the zones interacts by diffraction with a further portion of the illumination light that is incident on a further one of the zones. Regarding the zone plates 10, 19 described above in particular referring to FIGS. 2 and 3, such zones are zone rings. In the FIG. 4 embodiment of the zone plate 20, such zones have a different design which is described below.

This photon sieve embodiment of the zone plate 20 contains a multiplicity of holes or reflector structures 21a which are arranged on the different zone rings ZR₁ to ZR_{N} and are referred to as pinholes hereinafter. When the zone plate 20 is used instead of the zone plate 10 in the example of FIG. 1, the zone plate 20 is a transmissive zone plate that includes a multiplicity of holes. In this case, in FIG. 4, the areas with hatched lines represent regions with low transmissivity or high absorption, and the areas without hatched lines represent holes. A respective hole may be a physical hole where material is removed from the zone plate 20 or may be a region with high transmissivity or low absorption as compared to the hatched areas in FIG. 4. When the zone plate 20 is used instead of the zone plate 19 in the example of FIG. 2, the zone plate 20 is a reflective zone plate that includes a multiplicity of reflector structures. In this case, in FIG. 4, the areas with hatched lines represent regions with low reflectivity or high absorption, and the areas without hatched lines represent reflector structures.

The process description according to FIG. 4 illustrates how the photon sieve 20 is designed.

A zone plate with closed zone rings ZRᵢ as shown on the left in FIG. 4 is used as a starting point. Pinholes PHᵢ^{j} that are distributed randomly over a circumference of the respective zone ring ZRᵢ are now placed instead of closed zone rings Zrᵢ, as illustrated on the right in FIG. 4.

An innermost of the zone rings, ZR₁, has a total of six pinholes PH₁¹ to PH₁⁶ in the embodiment according to FIG. 4; these are numbered clockwise on the right in FIG. 4. There are 14 pinholes (PH₂¹ to PH₂¹⁴) in the closest radially outwardly adjacent zone ring ZR₂. There are approximately 60 pinholes (PH_{N}¹, . . . , PH_{N}⁶⁰) in the zone ring ZR_{N} shown by way of example radially at the very outside in FIG. 4.

A diameter of the respective pinholes PH₁^{j} corresponds to a radial width, i.e. a radial extent, of the respective zone ring ZRᵢ. In this example, the pinholes are positioned such that for each pinhole PH₁^{j}, the distance between the portion of the pinhole farthest from the center of the zone plate to the center of the zone plate is equal to the outer radius of the zone ring ZRᵢ, and the portion of the pinhole closest to the center of the zone plate to the center of the zone plate is equal to the inner radius of the zone ring ZRᵢ.

A pinhole diameter can also be greater than the radial extent of the respective zone ring and can be 1.5 times, 3.5 times or even 5.5 times the radial extent. A ratio between the pinhole diameter and a radial extent of the respective zone ring can therefore be in the range of between 0.5 and 10. A diameter of a focus for point illumination of the object 2 or a focus quality provided via the zone plate 10 can be improved by adjusting the ratio between the pinhole diameter and the radial extent of the respective zone ring. In this regard, reference is made to R. Menon's doctoral thesis: Diffractive optics for maskless lithography and imaging, Thesis (Ph. D.)—Massachusetts Institute of Technology, Dept. Of Electrical Engineering and Computer Science, 2003.

A diffraction effect of the photon sieve of the zone plate 20 can be predetermined in defined fashion by way of the radial distribution of the zone rings ZRᵢ, the dimensioning of the pinholes PH) and the number of pinholes PH₁^{j} in the respective zone ring ZRᵢ.

A person skilled in the art finds design details of photon sieves in the technical article “Huang, K. L. (2017). Huang, K., Liu, H., Si, G., Wang, Q., Lin, J., Teng, J., Laser & Photonics Reviews 2017, 11, 1700025. Laser & Photonics Reviews, p. 1700025.”

The pinholes PH₁^{j} of a particular zone ring ZRⱼ can be distributed in binary form within this zone ring ZRⱼ. Alternatively, the pinholes PH₁^{j} can be in non-binary form or gray scale, such as being 25%, 50%, and/or 75% transmissive or reflective.

With respect to a distribution in binary form, a cumulative circumference of holes, i.e. a pinhole diameter sum of all pinholes PH₁^{j} within this zone ring ZRⱼ, then corresponds to a cumulative interspace circumference of the interspaces between the pinholes PH₁^{j} adjacent in the circumferential direction within this zone ring ZRⱼ.

A radius crossing the center of the pinholes PH₁^{j} within the respective zone ring ZRⱼ thus on exactly half of its circumference crosses these pinholes, whereas on the other half of its circumference runs through the interspaces between these pinholes. For the innermost zone ring ZR₁, the cumulative circumference of holes is thus six times the diameter of a single pinhole PHᵢ¹. The cumulative interspace circumference is then the same size as the cumulative circumference of holes within this zone ring ZR₁. In the alternative, non-binary case, the cumulative circumference of holes within this zone ring may differ from the cumulative interspace circumference.

In the FIG. 4 embodiment, the pinholes have round shapes. In an alternative embodiment, the holes can have the shapes of, e.g., squares, triangles, arbitrary polygons, ovals, and/or other shapes. In principle, within a zone plate, different holes can have different shapes.

FIG. 5 illustrates a diffractive effect of the photon sieve zone plate 20, which is depicted in meridional section in this case. The effect of a transmissive photon sieve, in which the pinholes PHᵢ^{j} are designed as perforated stops, is shown.

A beam 3 of illumination light 4 incident from the left, schematically indicated by an arrow, is diffracted towards the illumination focus 14 in the object plane 13 in a +1st order of diffraction 21.

A zeroth order of diffraction 22 passes through the photon sieve zone plate 20 without being diffracted, wherein a surface-related intensity in the region of this zeroth order of diffraction is orders of magnitude lower than the intensity of the +1st order of diffraction in the illumination focus 14. Depending on the arrangement of the pinholes PH₁^{j}, the zeroth order of diffraction can also be suppressed to an even greater extent than what is indicated in FIG. 5.

FIG. 5 also shows the course of a −1st order of diffraction 23, which has a significantly lower surface intensity in comparison with the +1st order of diffraction 21 focused on the illumination focus 14.

Higher orders of diffraction are effectively suppressed on account of the arrangement of the pinholes PH₁^{j} of the photon sieve zone plate 20.

The photon sieve zone plate 20 can be embodied in such a way that a chromatic longitudinal aberration is avoided. In the first order of diffraction, different diffraction light wavelengths of the illumination light 4 are thus focused on the same z-focal position of the illumination focus 14. The photon sieve zone plate 20 therefore is chromatically corrected.

The photon sieve 20 is embodied such that the illumination focus 14 of the +1st order of diffraction is preferred in comparison with illumination foci of further orders of diffraction, for example +2nd, +3rd, . . . , as regards the used illumination intensity guided by the photon sieve zone plate 20. In this document, when we say that “the illumination focus 14 of the +1st order of diffraction is preferred in comparison with illumination foci of further orders of diffraction,” we mean that the illumination intensity of the illumination focus 14 of the +1st order of diffraction is higher than the illumination foci of further orders of diffraction.

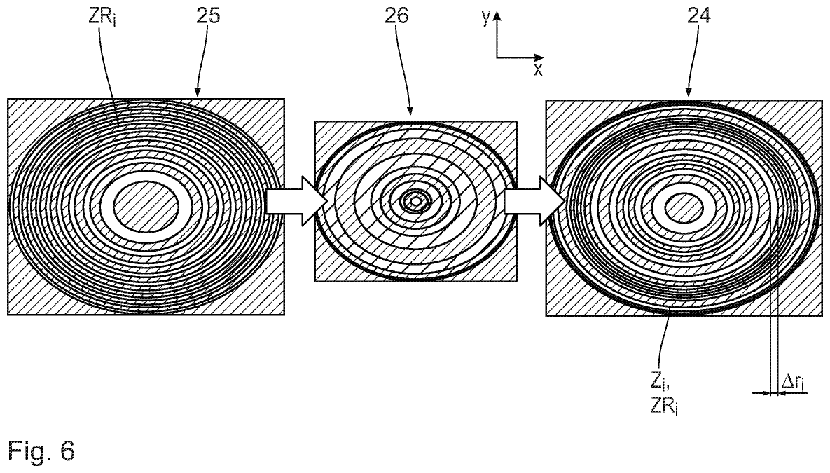

With reference to FIG. 6, a description is given below of an embodiment of a zone plate 24, which can be used instead of the zone plate 10 or 19. Components and functions corresponding to those which have already been explained above with reference to FIGS. 1 to 5 bear the same reference signs and will not be discussed in detail again.

FIG. 6 shows the embodiment of the zone plate 24 as a result of a design process description. The zone plate 24 has zones Zᵢ or zone rings ZRᵢ that are arranged in such a way that the zone plate 24 is aspherically corrected for the illumination light 4. The zone plate 24 thus has the effect of an aspherical lens element or an aspherical mirror. The zone plate 24 can thus be used to influence imaging parameters of the optical system 8.

Starting point for the design of the aspherical zone plate 24 is a raw zone plate 25 with spherical wavefront effect of the zone rings ZRᵢ, as shown on the left in FIG. 6.

An aspherical correction function 26 is impressed on the zone distribution of this raw zone plate 25, as illustrated in FIG. 6, center. For example, this correction function might have significant contributions of the radially symmetric Zernike polynomial Z36.

This aspherical correction results in a discontinuous distribution of ring widths Δrᵢ or radial extents of the zone rings ZRᵢ, as illustrated in FIG. 6. This ring width Δrᵢ first decreases starting from the center of the aspheric zone plate 24 and then increases again in a middling radius region, decreases again, and then becomes larger again radially outwards before it reduces again right at the outside in the region of the outermost zone rings ZR_{N-1}, ZR_{N}. This corresponds to a curve of the Zernike polynomial Z36. FIGS. 7 to 10 are used to describe further embodiments of zone plates below, which in each case have a reflective embodiment for the illumination light 4, i.e. can be used instead of the zone plate 19 according to FIG. 2. Components and functions corresponding to those which have already been explained above with reference to FIGS. 1 to 6 bear the same reference signs and will not be discussed in detail again.

FIG. 7 shows an embodiment of a reflective zone plate 27 in cross section or meridional section.

The reflective zone plate 27 has a zone layer 28, which comprises the zones Zᵢ arranged on the zone rings ZRᵢ. Zones Zᵢ of the zone layer 28 of the zone plate 27 each have a rectangular profile or an approximately rectangular profile.

This zone layer 28 is applied to a base reflection layer 29 of the zone plate 27. At the same time, the zone layer 28 is part of an overall reflection layer 28, 29, which is constructed as a multilayer layer with alternating laminas L₁, L₂ or L₁, L₂, L₃ made of materials with different refractive indices.

The zone layer 28 itself represents a multilayer portion of the overall reflection layer 28, 29. The zones Zᵢ of zone layer 28 themselves are constructed as stacks of individual laminas Lᵢ of the multilayer layer.

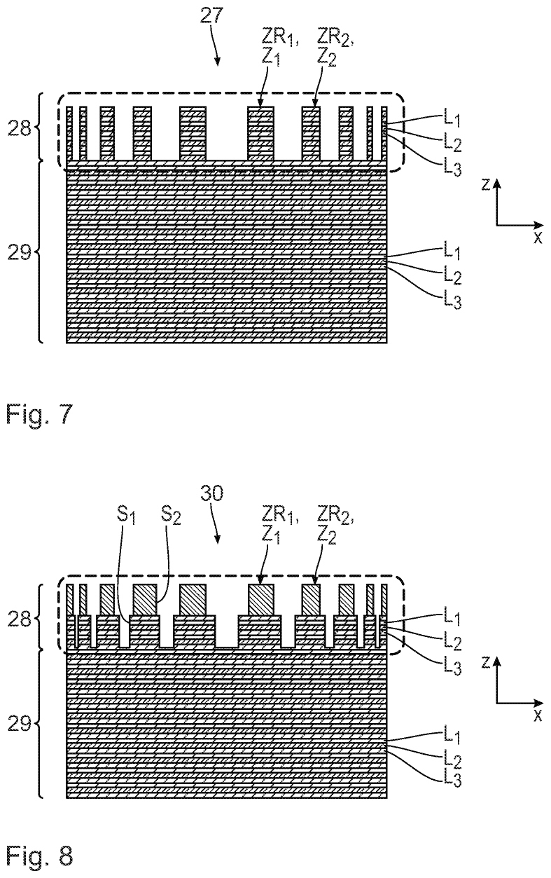

FIG. 8 shows a variant of a reflective zone plate 30, in which the zone layer has 28 zones Zᵢ that deviate from a rectangular profile in meridional section.

In the zone plate 30, the zones Zᵢ are designed as a step profile with steps S₁ and S₂. A lower step profile of the step S₁ protrudes radially to both sides beyond the upper step profile of the step S₂, and so step protrusions of the lower step profile S₁ arise on both sides of the upper step profile S₂. A step profile like that shown in FIG. 8 has manufacturing advantages.

The upper step profiles S₂ of the zones Zᵢ are made of absorber material, and the lower step profiles S₁ are embodied as multilayer layers with alternating laminas Lᵢ, as already explained above in connection with FIG. 7.

The zone layer 28 of the reflective zone plate 30 is carried in turn by a base reflection layer 29 corresponding to the embodiment according to FIG. 7.

The absorber material absorbs the illumination light 4 at least in part or even in full.

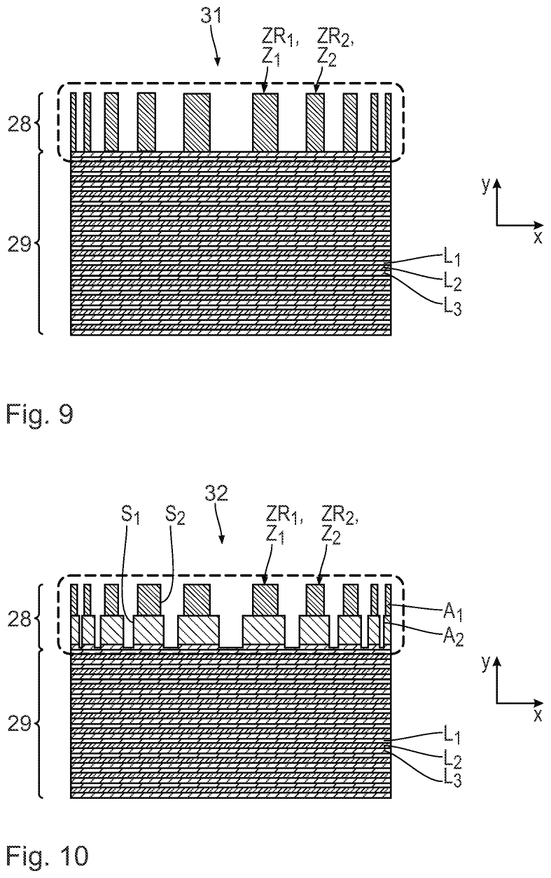

FIG. 9 shows a further variant of a reflective zone plate 31, which can be used instead of the zone plate 27 or 30. In the zone plate 31, a zone layer 28 is formed from zones Zᵢ made up entirely from the absorber material. A profile of the zones Zᵢ of the zone layer 28 of the zone plate 31 corresponds to the rectangular profile in the zone plate 27 according to FIG. 7.

This zone layer with the zones Zᵢ made of the absorber material is carried by the reflection layer 29 in the zone plate 31.

FIG. 10 shows a further embodiment of a reflective zone plate 32, which can be used instead of the zone plate 27, 30 or 31.

Zones Zᵢ of a zone layer 28 of the reflective zone plate 32 are step-shaped like the zones Zᵢ of the zone plate 30 according to FIG. 8. In this case, the lower step profile S₁ is made of a first absorber material A₁, and the overlying step profile S₂ is made of a second absorber material A₂. The absorber materials A₁, A₂ of the step profiles S₁ and S₂ differ from each other in terms of their absorbing effect for the illumination light 4.

Examples of materials for the individual laminas Lᵢ of the multilayer layers are molybdenum (Mo), silicon (Si) or else beryllium (Be). Examples of materials for the absorber material are TiN, Cr, TaN, TaBN and TaBO.

The zones Zᵢ of the zone layer 28 are also carried by the multilayer reflection layer 29 in the zone plate 32.

The zone plates 30, 31 and 32 each exhibit different combinations regarding manufacturing effort and optical properties.

Zone plates like the zone plates 30, 31 and 32 can be used to increase a wavelength bandwidth of a zone plate. The resulting zone plate can be understood to be a superimposition of a plurality of zone plates, for example a superimposition of two or three zone plates, each of which is optimized for a different target wavelength. One of these wavelengths can be the wavelength of the used illumination light 4. The other wavelengths can be adjacent wavelengths or else more distant wavelengths.

This can be used to design zone plates like the zone plates 30, 31, 32, which are chromatically corrected with respect to the used wavelength of the illumination light 4. A person skilled in the art finds details regarding the design of corresponding chromatically corrected zone plates in the technical article “Cai. H. et al. (2019), Ultrathin transmissive metasurfaces for multi-wavelength optics in the visible. Appl. Phys. Lett., S071106.”

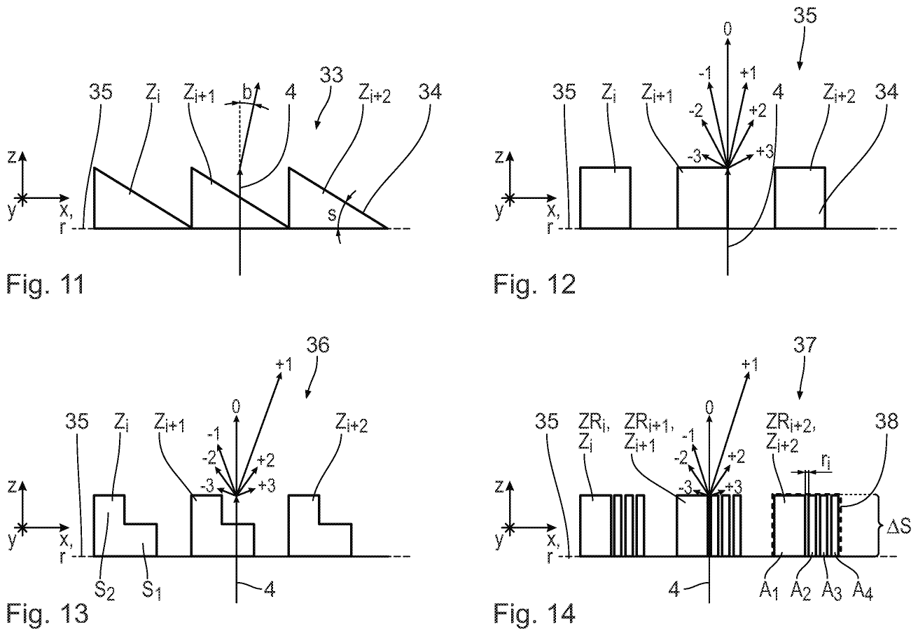

FIGS. 11 to 16 are used below to describe further zone plate embodiments with zones Zᵢ that deviate from a rectangular profile in cross section or meridional section. Components and functions corresponding to those which have already been explained above with reference to FIGS. 1 to 10 bear the same reference signs and will not be discussed in detail again.

FIG. 11 shows a zone plate 33 with zones Zᵢ, Zᵢ₊₁, Zᵢ₊₂, which have a sawtooth profile in cross section or meridional section. The zone plate 33 represents a transmitting phase plate.

An oblique surface 34 of the respective zone Zᵢ can be adapted with respect to its surface angle s to a plate plane 35 of the zone plate 33, which runs parallel to the xy-plane, such that a blazed zone plate 33 results. In that case, the angle s is a blaze angle which can be adapted at the zone plate 33 to the used wavelength of the illumination light 4 such that only a +1st order of diffraction of the illumination light 4 is guided constructively by the zone plate 33.

This is schematically indicated in FIG. 11 for a transmissive variant of the zone plate 33, where the illumination light 4 is radiated in from below, and there is constructive guidance of a +1st order of diffraction, which is deflected through a diffraction angle b. Other orders of diffraction of the incident illumination light 4 are largely or completely suppressed in this sawtooth profile design of the zones Zᵢ of the zone plate 33.

For the zone plate 33, the +1st order of diffraction thus represents a predetermined order of diffraction which is preferred in comparison with at least one further order of diffraction as regards a used illumination light intensity guided by the zone plate 33.

FIG. 12 shows, in comparison with the blaze effect of the zone plate 33, an embodiment of a zone plate 35 in which the zones Zᵢ are embodied as rectangular profiles.

A diffraction effect of such a rectangular profile design of the zones Zᵢ of the zone plate 35 is illustrated in FIG. 12 in a manner analogous to the illustration according to FIG. 11. The diffraction light 4, which in turn is incident from below, is split into a plurality of orders of diffraction, specifically a −3rd, a −2nd, a −1st, a 0th, a +1st, a +2nd and a +3rd order of diffraction. In terms of absolute value, higher orders of diffraction are also possible, but have a negligible diffraction intensity in comparison with the displayed orders of diffraction. In comparison with the zone plate 33, only a comparatively small proportion of an overall incident illumination light energy is diffracted into the +1st order of diffraction.

FIG. 13 shows a further variant of zones Zᵢ, whose profile differs from a rectangular profile. This case of zone plate 36 again has step-shaped zones Zᵢ with step profiles S₁, S₂. The step profile S₁ at the bottom in FIG. 13 has a greater radial extent than the step profile S₂ at the top, for example a radial extent of twice the size. The lower step profile S₁ only protrudes beyond the top step profile S₂ in one radial direction, for example along the positive r coordinate. Overall, the step-shaped zones Zᵢ of the zone plate 36 can be understood to be an approximation to the sawtooth profile of the zones Zᵢ of the zone plate 33 according to FIG. 11.

With regard to the diffraction characteristic likewise indicated in FIG. 13 in a manner analogous to FIGS. 11 and 12, a preference for the +1st order of diffraction also emerges for the step profile according to FIG. 13, in accordance with the blaze variant according to FIG. 11, wherein the other orders of diffraction −3, −2, −1, 0, +2 and +3 are not completely suppressed in the zone plate 36 according to FIG. 13.

FIG. 14 shows a variant of a zone plate 37 with a diffraction effect comparable to that of the zone plate 36 according to FIG. 3. In the zone plate 37, the individual zones Zᵢ are embodied in the form of a subdivision of a rectangular envelope 38 of the respective zone ring ZRᵢ. Such a rectangular envelope 38 is indicated in FIG. 14 using dashed lines at the zone ring ZRᵢ₊₂.

In the zone plate 37, the rectangular envelope 38 is subdivided into a plurality of radially spaced profile sections A₁, A₂,A₃ and A₄ of the same step height. Radial extents of the profile sections Aᵢ and the radial distances rᵢ between the adjacent profile sections Aᵢ, Aᵢ₊₁ and a step height ΔS are matched to one another in such a way that the diffraction effect as indicated in FIG. 14 emerges, in the case of which the +1st order of diffraction of the illumination light 4 is preferred in turn.

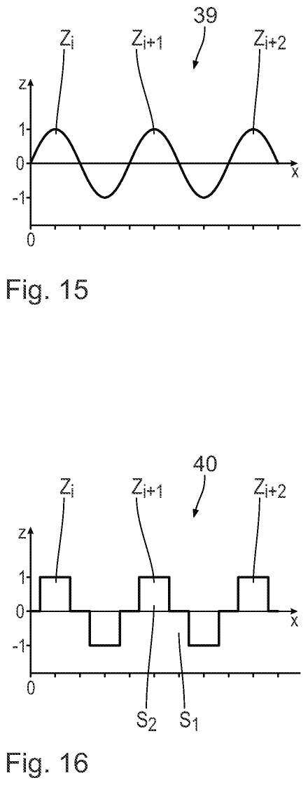

FIG. 15 shows a further embodiment of a zone plate 39 with zones Zᵢ that deviate from a rectangular profile. Similar to FIGS. 11 to 14, three radially adjacent zones Zᵢ, Zᵢ₊₁ and Zᵢ₊₂ are shown once again in FIG. 15. A cross section or meridional profile of these zones of the zone plate 39 is a sinusoidal profile or a profile that approximates a sinusoidal profile. Assuming a corresponding adaptation of a period and an amplitude of the sinusoidal profile, the zone plate 39 has a diffractive effect for incident diffraction light 4 in reflection or else in transmission, in the case of which diffractive effect the illumination light 4 is only guided into a +1st and a −1st order of diffraction, wherein the other orders of diffraction are at least largely or else completely suppressed.

For the zone plate 39, the +/−1st orders of diffraction accordingly represent predetermined orders of diffraction which are preferred in comparison with the other orders of diffraction as regards the used illumination light intensity guided by the zone plate.

FIG. 16 shows a further embodiment of a zone plate 40 with a profile of the zones Zᵢ that deviates from a rectangular profile in cross section or meridional section. In the zone plate 40, the zones Zᵢ are embodied as a step profile and approximate the sinusoidal profile of the zone plate 39.

In a manner comparable to the profile according to FIGS. 8 and 10, the stepped profiles once again have a lower step profile S₁ and an upper step profile S₂, wherein the lower step profile S₁ protrudes equally beyond the upper step profile S₂ on both sides in order to approximate a sine curve. A distance between adjacent lower step profiles S₁ corresponds to a radial extent of the upper step profile S₂.

The step profile of the zone plate 40 approximates the sinusoidal profile according to FIG. 15 over a total of three step levels. In an alternative, it is also possible for an approximation to have a different number of step levels, for example four, five, six or even more step levels. The greater the number of step levels, the better an approximation to a sinusoidal profile can be achieved.

Accordingly, the diffraction effect for the zone plate 40 according to FIG. 16 or for a corresponding zone plate with sinusoidal profile approximated by a greater number of step levels results in a diffraction effect in which the +1st and the −1st orders of diffraction of the illumination light 4 are preferred.

To measure the structure of the object 2, an image of the object structure in the object field 12 is constructed by the detection device 6 by successively scanning the individual points of the object structure in the x/y direction. Depending on the measurement method, either a single image is recorded or an image stack (aerial image) in a plurality of z-positions, in which case the object 2 is displaced into corresponding z-positions by use of the object holder 15 and the actuator 16.

Although the present invention is defined in the attached claims, it should be understood that the present invention can also be defined in accordance with the following embodiments:

Embodiment 1: Optical system (8) for a metrology system (1) for measuring an object (2),
having an object holder (15) for holding an object (2) in an object plane (13),
having an optical focusing component (10; 19; 20; 24; 27; 30; 31; 32; 33; 35; 36; 37; 39; 40) arranged in the beam path of illumination light (4) between a light source (5) of the metrology system (1) and an object field (12) in the object plane (13) and serving to create an illumination focus (14) in the beam path of illumination light (4) downstream of the optical focusing component (10; 19; 20; 24; 27; 30; 31; 32; 33; 35; 36; 37; 39; 40),
having a detection device (6) for capturing the illumination light (4) in the beam path downstream of the object field (12),
wherein the optical focusing component (10; 19; 20; 24; 27; 30; 31; 32; 33; 35; 36; 37; 39; 40) is embodied as a zone plate with at least two zones (Zᵢ, Zᵢ₊₁), wherein a portion of the illumination light (4) that is incident on a first (Zᵢ) of the zones interacts by diffraction with a further portion of the illumination light (4) that is incident on a further one (Zᵢ₊₁) of the zones,
wherein
   the zones (Zᵢ) of the zone plate (20; 30; 32) are arranged in such a way that the zone plate (20; 30; 32) is chromatically corrected for the illumination light (4), and/or
   the zones (Zᵢ) of the zone plate (24) are arranged in such a way that the zone plate (24) is aspherically corrected for the illumination light (4).

Embodiment 2: Optical system (8) for a metrology system (1) for measuring an object (2),
having an object holder (15) for holding an object (2) in an object plane (13),
having an optical focusing component (10; 19; 20; 24; 27; 30; 31; 32; 33; 35; 36; 37; 39; 40) arranged in the beam path of illumination light (4) between a light source (5) of the metrology system (1) and an object field (12) in the object plane (13) and serving to create an illumination focus (14) in the beam path of illumination light (4) downstream of the optical focusing component (10; 19; 20; 24; 27; 30; 31; 32; 33; 35; 36; 37; 39; 40),
having a detection device (6) for capturing the illumination light (4) in the beam path downstream of the object field (12),
wherein the optical focusing component (10; 19; 20; 24; 27; 30; 31; 32; 33; 35; 36; 37; 39; 40) is embodied as a zone plate with at least two zones (Zᵢ, Zᵢ₊₁), wherein a portion of the illumination light (4) that is incident on a first (Zᵢ) of the zones interacts by diffraction with a further portion of the illumination light (4) that is incident on a further one (Zᵢ₊₁) of the zones,
wherein
   the zones (Zᵢ) of the zone plate (19; 20; 24; 27; 30; 31; 32; 33; 35; 36; 37; 39; 40) have a reflective embodiment for the illumination light (4), and/or
   the zones (Zᵢ) of the zone plate (10; 19; 20; 24; 27; 30; 31; 32; 33; 36; 37; 39; 40) are arranged in such a way that at least one order of diffraction (+1; +/−1) of the illumination light (4) is preferred as predetermined order of diffraction in comparison with at least one further order of diffraction as regards the used illumination light intensity guided by the zone plate (10; 19; 20; 24; 27; 30; 31; 32; 33; 36; 37; 39; 40),
wherein a focal length of the optical focusing component (10; 19; 20; 24; 27; 30; 31; 32; 33; 35; 36; 37; 39; 40) is no more than 10 mm.

Embodiment 3: Optical system according to Embodiment 1 or 2, characterized in that the zones (Zᵢ) are arranged in the form of a ring, with the zone rings (Zrᵢ) in the zone plate (10; 19; 20; 24; 27; 30; 31; 32; 33; 35; 36; 37; 39; 40) totalling more than 100.

Embodiment 4: Optical system according to any of Embodiments 1 to 3, characterized in that the zone plate (10; 20; 24; 33; 35; 36; 37; 39; 40) is embodied as a transmitting phase plate, the zones (Zᵢ) each having a different influence on the phase of the illumination light (4) incident on the zone plate (10; 20; 24; 33; 35; 36; 37; 39; 40).

Embodiment 5: Optical system according to any of Embodiments 1 to 4, characterized in that the zone plate (20) is embodied as a photon sieve.

Embodiment 6: Optical system according to Embodiment 5, characterized in that the photon sieve (20) is embodied such that an illumination light focus (14) of a specific order of diffraction (+1) is preferred in comparison with an illumination light focus of at least one further order of diffraction as regards the used illumination light intensity guided by the zone plate.

Embodiment 7: Optical system according to any of Embodiments 1 to 6, characterized in that an aspherical correction is impressed via a discontinuous radial distribution of ring widths (Δrᵢ) of the zone rings (ZRᵢ) of the zone plate or of pinholes of the photon sieve (20).

Embodiment 8: Optical system according to any of Embodiments 1 to 7, characterized in that a zone layer (28) comprising the zones (Zᵢ) is applied to a reflection layer (29) of the zone plate (27; 30; 31; 32).

Embodiment 9: Optical system according to Embodiment 8, characterized in that the zone layer (28) comprises at least one absorber layer made of an absorber material.

Embodiment 10: Optical system according to Embodiment 8 or 9, characterized in that the reflection layer (28, 29) is embodied as a multilayer layer, wherein the zone layer (28) comprises at least a multilayer portion of the reflection layer (28, 29).

Embodiment 11: Optical system according to any of Embodiments 1 to 10, characterized in that at least some of the zones (ZRᵢ) deviate from a rectangular profile in the meridional section of the zone plate (33; 36; 37; 39).

Embodiment 12: Metrology system (1) for measuring an object (2),
having an optical system according to any of Embodiments 1 to 11,
having a light source (5) for creating illumination light (4).

Embodiment 13: Metrology system according to Embodiment 12, characterized in that the light source (5) is an EUV light source.

A number of implementations have been described. Nevertheless, it will be understood that various modifications may be made. For example, the elements of one or more implementations may be combined, deleted, modified, or supplemented to form further implementations. In addition, other components may be added to, or removed from, the described metrology system. For example, the dimensions, radii, radial extents, shapes, and/or positions of various components of the zone plates, such as zone rings, reflective structures, or holes, can have values different from the examples described above. Accordingly, other implementations are within the scope of the following claims

What is claimed is:

1. An optical system for a metrology system for measuring an object,
having an object holder for holding an object in an object plane,
having an optical focusing component arranged in the beam path of illumination light between a light source of the metrology system and an object field in the object plane and serving to create an illumination focus in the beam path of illumination light downstream of the optical focusing component, and
having a detection device for capturing the illumination light in the beam path downstream of the object field,
wherein the optical focusing component is embodied as a zone plate with at least two zones, wherein a portion of the illumination light that is incident on a first of the zones interacts by diffraction with a further portion of the illumination light that is incident on a further one of the zones,
wherein
the zones of the zone plate are arranged in such a way that the zone plate is chromatically corrected for the illumination light, and/or
the zones of the zone plate are arranged in such a way that the zone plate is aspherically corrected for the illumination light.

2. An optical system for a metrology system for measuring an object,
having an object holder for holding an object in an object plane,
having an optical focusing component arranged in the beam path of illumination light between a light source of the metrology system and an object field in the object plane and serving to create an illumination focus in the beam path of illumination light downstream of the optical focusing component, and
having a detection device for capturing the illumination light in the beam path downstream of the object field,
wherein the optical focusing component is embodied as a zone plate with at least two zones wherein a portion of the illumination light that is incident on a first of the zones interacts by diffraction with a further portion of the illumination light that is incident on a further one of the zones,
wherein
the zones of the zone plate have a reflective embodiment for the illumination light, and/or
the zones of the zone plate are arranged in such a way that at least one order of diffraction of the illumination light is preferred as predetermined order of diffraction in comparison with at least one further order of diffraction as regards the used illumination light intensity guided by the zone plate,
wherein a focal length of the optical focusing component is no more than 10 mm.

3. The optical system of claim 1, wherein the zones are arranged in the form of a ring, with the zone rings in the zone plate totalling more than 100.

4. The optical system of claim 1, wherein the zone plate is embodied as a transmitting phase plate, the zones each having a different influence on the phase of the illumination light incident on the zone plate.

5. The optical system of claim 1, wherein the zone plate is embodied as a photon sieve.

6. The optical system of claim 5, wherein the photon sieve is embodied such that an illumination light focus of a specific order of diffraction is preferred in comparison with an illumination light focus of at least one further order of diffraction as regards the used illumination light intensity guided by the zone plate.

7. The optical system of claim 1, wherein an aspherical correction is impressed via a discontinuous radial distribution of ring widths of the zone rings of the zone plate or of pinholes of the photon sieve.

8. The optical system of claim 1, wherein a zone layer comprising the zones is applied to a reflection layer of the zone plate.

9. The optical system of claim 8, wherein the zone layer comprises at least one absorber layer made of an absorber material.

10. The optical system of claim 8, wherein the reflection layer is embodied as a multilayer layer, wherein the zone layer comprises at least a multilayer portion of the reflection layer.

11. The optical system of claim 1, wherein at least some of the zones deviate from a rectangular profile in the meridional section of the zone plate.

12. A metrology system for measuring an object,
having an optical system according to claim 1, and
having a light source for creating illumination light.

13. The metrology system of claim 12, wherein the light source is an EUV light source.

14. The optical system of claim 2, wherein the zones are arranged in the form of a ring, with the zone rings in the zone plate totalling more than 100.

15. The optical system of claim 2, wherein the zone plate is embodied as a transmitting phase plate, the zones each having a different influence on the phase of the illumination light incident on the zone plate.

16. The optical system of claim 2, wherein the zone plate is embodied as a photon sieve.

17. The optical system of claim 2, wherein an aspherical correction is impressed via a discontinuous radial distribution of ring widths of the zone rings of the zone plate or of pinholes of the photon sieve.

18. The optical system of claim 2, wherein a zone layer comprising the zones is applied to a reflection layer of the zone plate.

19. The optical system of claim 2, wherein at least some of the zones deviate from a rectangular profile in the meridional section of the zone plate.

20. The metrology system of claim 12, wherein each of the zones is arranged in the form of a ring, with the zone rings in the zone plate totalling more than 100.
